(19) United States
(12) Patent Application Publication
(10) Pub. No.: US 2019/0314771 A1
(43) Pub. Date: Oct. 17, 2019

(54) HIGH SELECTIVITY POLY(IMIDE-URETHANE) MEMBRANES FOR GAS SEPARATIONS

(71) Applicant: UOP LLC, Des Plaines, IL (US)

(72) Inventor: Chunqing Liu, Arlington Heights, IL (US)

(21) Appl. No.: 15/955,522

(22) Filed: Apr. 17, 2018

(51) Int. Cl. B01D 71/76; B01D 71/54; B01D 71/64; B01D 53/22; C08J 3/24

(52) U.S. Cl. CPC B01D 71/76; B01D 71/54; B01D 71/64; B01D 53/228; C08J 2379/08; B01D 2311/2653; B01D 2311/268; C08J 2375/12; C08J 3/246

(57) ABSTRACT

This invention pertains to high selectivity poly(imide-urethane) membrane and a method of making the same. This invention also pertains to applications of the high selectivity poly(imide-urethane) membranes not only for a variety of gas separations such as separations of carbon dioxide/methane, hydrogen/methane, helium/methane, oxygen/nitrogen, carbon dioxide/nitrogen, olefin/paraffin, iso/normal paraffins, xylenes, polar molecules such as water, hydrogen sulfide and ammonia/mixtures with methane, nitrogen, or hydrogen and other light gases separations, but also for liquid separations such as pervaporation and desalination.

### FIELD

This invention pertains to high selectivity poly(imide-urethane) membrane and a method of making the same. This invention also pertains to applications of the high selectivity poly(imide-urethane) membranes not only for a variety of gas separations such as separations of carbon dioxide/methane, hydrogen/methane, helium/methane, oxygen/nitrogen, carbon dioxide/nitrogen, olefin/paraffin, iso/normal paraffins, xylenes, polar molecules such as water, hydrogen sulfide and ammonia/mixtures with methane, nitrogen, or hydrogen and other light gases separations, but also for liquid separations such as pervaporation and desalination.

### BACKGROUND

In the past 30-35 years, the state of the art of polymer membrane-based gas separation processes has evolved rapidly. Membrane-based technologies have advantages of both low capital cost and high-energy efficiency compared to conventional separation methods. Membrane gas separation is of special interest to petroleum producers and refiners, chemical companies, and industrial gas suppliers. Several applications of membrane gas separation have achieved commercial success, including N₂ enrichment from air, carbon dioxide removal from natural gas and from enhanced oil recovery, and also in hydrogen removal from nitrogen, methane, and argon in ammonia purge gas streams. For example, UOP's Separex™ cellulose acetate spiral wound polymeric membrane is currently an international market leader for carbon dioxide removal from natural gas.

Polymers provide a range of properties including low cost, permeability, mechanical stability, and ease of processability that are important for gas separation. Glassy polymers (i.e., polymers at temperatures below their T_{g}) have stiffer polymer backbones and therefore let smaller molecules such as hydrogen and helium pass through more quickly, while larger molecules such as hydrocarbons pass through more slowly as compared to polymers with less stiff backbones. Cellulose acetate (CA) glassy polymer membranes are used extensively in gas separation. Currently, such CA membranes are used for natural gas upgrading, including the removal of carbon dioxide. Although CA membranes have many advantages, they are limited in a number of properties including selectivity, permeability, and in chemical, thermal, and mechanical stability.

The membranes most commonly used in commercial gas and liquid separation applications are asymmetric polymeric membranes and have a thin nonporous selective skin layer that performs the separation. Separation is based on a solution-diffusion mechanism. This mechanism involves molecular-scale interactions of the permeating gas with the membrane polymer. The mechanism assumes that in a membrane having two opposing surfaces, each component is sorbed by the membrane at one surface, transported by a gas concentration gradient, and desorbed at the opposing surface. According to this solution-diffusion model, the membrane performance in separating a given pair of gases (e.g., CO₂/CH₄, O₂/N₂, H₂/CH₄) is determined by two parameters: the permeability coefficient (abbreviated hereinafter as permeability or P_{A}) and the selectivity (α_{A/B}). The P_{A} is the product of the gas flux and the selective skin layer thickness of the membrane, divided by the pressure difference across the membrane. The α_{A/B} is the ratio of the permeability coefficients of the two gases (α_{A/B}=P_{A}/P_{B}) where P_{A} is the permeability of the more permeable gas and P_{B} is the permeability of the less permeable gas. Gases can have high permeability coefficients because of a high solubility coefficient, a high diffusion coefficient, or because both coefficients are high. In general, the diffusion coefficient decreases while the solubility coefficient increases with an increase in the molecular size of the gas. In high performance polymer membranes, both high permeability and selectivity are desirable because higher permeability decreases the size of the membrane area required to treat a given volume of gas, thereby decreasing capital cost of membrane units, and because higher selectivity results in a higher purity product gas.

One of the components to be separated by a membrane must have a sufficiently high permeance at the preferred conditions or extraordinarily large membrane surface areas is required to allow separation of large amounts of material. Permeance, measured in Gas Permeation Units (GPU, 1 GPU=10⁻⁶ cm³ (STP)/cm² s (cm Hg)), is the pressure normalized flux and equals to permeability divided by the skin layer thickness of the membrane. Commercially available gas separation polymer membranes, such as CA, polyimide, and polysulfone membranes formed by phase inversion and solvent exchange methods have an asymmetric integrally skinned membrane structure. Such membranes are characterized by a thin, dense, selectively semipermeable surface “skin” and a less dense void-containing (or porous), non-selective support region, with pore sizes ranging from large in the support region to very small proximate to the “skin”. However, fabrication of defect-free high selectivity asymmetric integrally skinned polyimide membranes is difficult. The presence of nanopores or defects in the skin layer reduces the membrane selectivity. The high shrinkage of the polyimide membrane on cloth substrate during membrane casting and drying process results in unsuccessful fabrication of asymmetric integrally skinned polyimide membranes using phase inversion technique.

In order to combine high selectivity and high permeability together with high thermal stability, new high-performance polymers such as polyimides (PIs), poly(trimethylsilylpropyne) (PTMSP), and polytriazole were developed. These new polymeric membrane materials have shown promising properties for separation of gas pairs like CO₂/CH₄, O₂/N₂, H₂/CH₄, and C₃H₆/C₃H₈. However, current polymeric membrane materials have reached a limit in their productivity-selectivity trade-off relationship. In addition, gas separation processes based on glassy polymer membranes frequently suffer from plasticization of the stiff polymer matrix by the sorbed penetrating molecules such as CO₂ or C₃H₆. Plasticization of the polymer is exhibited by swelling of the membrane structure and by a significant increase in the permeances of all components in the feed and decrease of selectivity occurring above the plasticization pressure when the feed gas mixture contains condensable gases. Plasticization is particularly an issue for gas fields containing high CO₂ concentrations and heavy hydrocarbons and for systems requiring two-stage membrane separation.

The present invention discloses high selectivity poly(imide-urethane) membranes and methods of making and using these membranes.

### SUMMARY

This invention involves a composition, a method of making, and an application of high selectivity poly(imide-urethane) membranes. The poly(imide-urethane) membranes described in the present invention showed high stability in any organic solvents, high hydrocarbon plasticization resistance, and high selectivity for He/CH₄ and H₂/CH₄ separations.

The high selectivity poly(imide-urethane) membranes described in this invention are highly promising not only for a variety of gas separations such as separations of He/CH₄, CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases separations, but also for liquid separations such as desalination and pervaporations.

### DETAILED DESCRIPTION

Current polymeric membrane materials have reached a limit in their productivity-selectivity trade-off relationship for separations. In addition, gas separation processes based on glassy solution-diffusion membranes frequently suffer from plasticization of the stiff polymer matrix by the sorbed condensable penetrant molecules such as CO₂ or C₃H₆. Plasticization of the polymer represented by the membrane structure swelling and significant increase in the permeabilities of all components in the feed occurs above the plasticization pressure when the feed gas mixture contains condensable gases.

For example, for cellulose acetate (CA) membrane, the high solubility of CO₂ swells the polymer to such an extent that intermolecular interactions are disrupted. As a result, mobility of the acetyl and hydroxyl pendant groups, as well as small-scale main chain motions, would increase thereby enhancing the gas transport rates. See Puleo, et al., J. MEMBR. SCI., 47: 301 (1989). This result indicates a strong need to develop new plasticization-resistant membrane materials. The markets for membrane processes could be expanded considerably through the development of robust, high plasticization-resistant, and high selectivity membrane materials.

This invention pertains to high selectivity poly(imide-urethane) membranes. More specifically, this invention pertains to a method for making these high selectivity poly(imide-urethane) membranes. This invention also pertains to the applications of these high selectivity poly(imide-urethane) membranes not only for a variety of gas separations such as separations of He/CH₄, CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases separations, but also for liquid separations such as desalination and pervaporations.

The high selectivity poly(imide-urethane) membrane described in the present invention comprises poly(imide-urethane) polymer with a plurality of repeating units of formula (I):

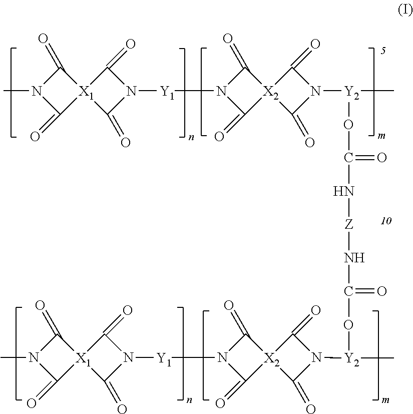

wherein X₁ and X₂ are selected from the group consisting of

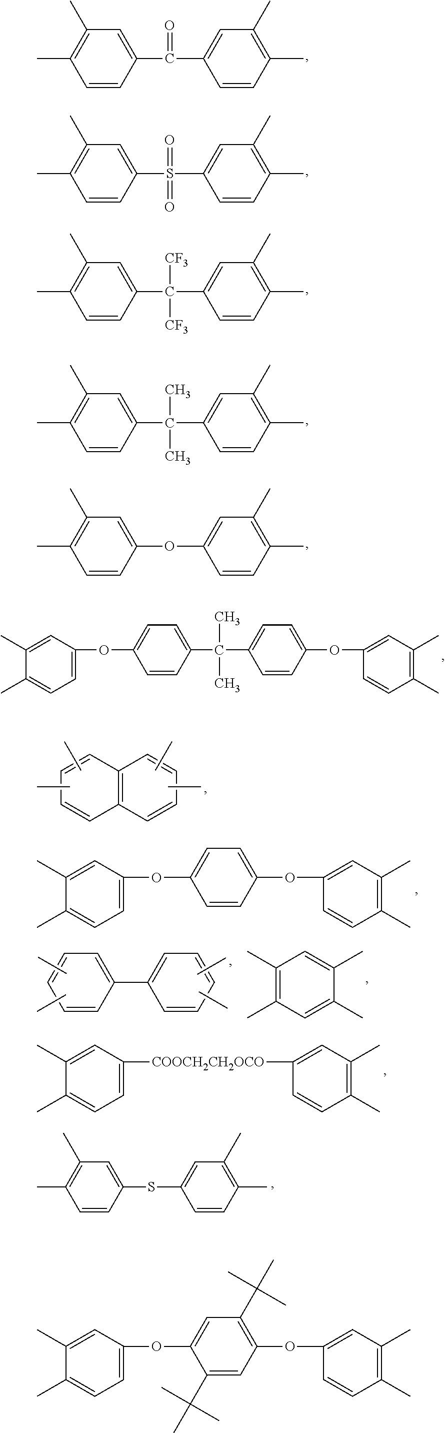

and mixtures thereof, respectively; X₁ and X₂ are the same or different from each other; Y₁ is selected from the group consisting of

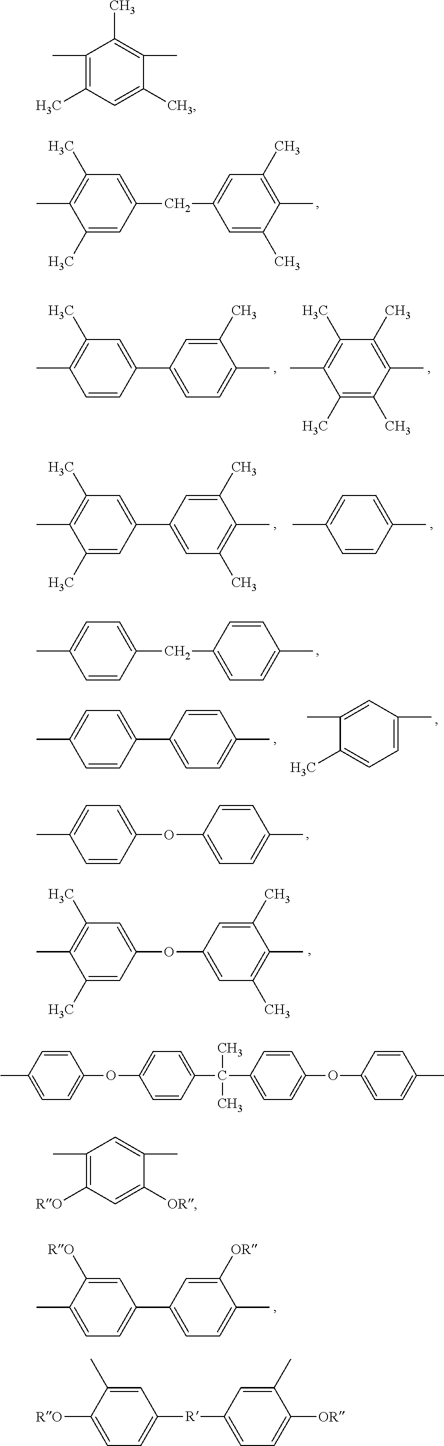

and mixtures thereof, and —R′— is selected from the group consisting of

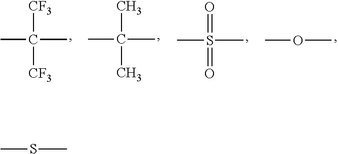

and mixtures thereof, and —R″— is selected from the group consisting of —H, COCH₃, and mixtures thereof; Y₂—O— is selected from the group consisting of

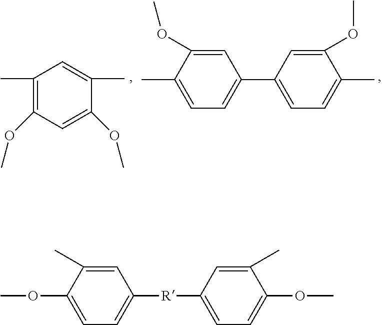

and mixtures thereof, and —R′— is selected from the group consisting of

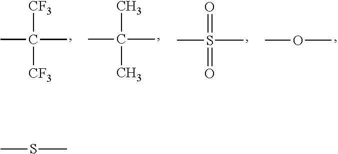

and mixtures thereof; —Z— is selected from the group consisting of

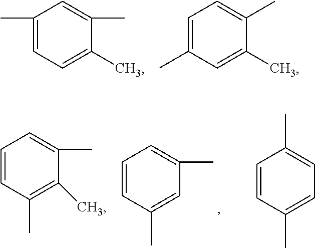

and mixtures thereof; n and m are independent integers from 2 to 500; the molar ratio of n/m is in a range of 1:20 to 20:1.

The present invention provides a method for the production of the high selectivity poly(imide-urethane) membrane by: 1) preparing an organic solution consisting of certain mole ratio of an organo diisocyanate such as toluene-2,4-diisocyanate and a polyimide comprising hydroxyl functional groups that can react with the isocyanate groups; 2) forming a poly(imide-urethane) pre-polymer solution by allowing the two chemicals to react for at least 4 hours at 30-150° C.; 3) coating the poly(imide-urethane) pre-polymer solution on a porous polymeric membrane substrate or on a polymeric cloth substrate or on a clean glass plate; 4) removing the organic solvents from the coating layer to form a membrane; 5) drying and curing the poly(imide-urethane) pre-polymer membrane to form poly(imide-urethane) polymer membrane. In some cases, the poly(imide-urethane) polymer selective layer surface of the membrane is coated with a thin layer of high permeability material such as a polysiloxane, a fluoro-polymer, a thermally curable silicone rubber, or a UV radiation curable epoxy silicone.

The high selectivity poly(imide-urethane) membrane described in the present invention can be fabricated into any convenient geometry such as flat sheet (or spiral wound), tube, or hollow fiber.

The high selectivity poly(imide-urethane) membrane described in the present invention comprises both imide segments and urethane segments that provide high selectivities for gas separations. The high selectivity poly(imide-urethane) membrane described in the present invention showed high selectivity and good permeability for a variety of gas separation applications such as CO₂/CH₄, H₂/CH₄, and He/CH₄ separations. For example, a poly[2,2′-bis-(3,4-dicarboxyphenyl) hexafluoropropane dianhydride-3,3′-dihydroxy-4,4′-diamino-biphenyl] polyimide-toluene-2,4-diurethane (abbreviated as 6FDA-HAB-TDI-5-4, molar ratio of HAB/TDI=5:4) membrane has He permeance of 14.8 Barrers and high He/CH₄ selectivity of 651 for He/CH₄ separation. The 6FDA-HAB-TDI-5-4 membrane also has H₂ permeance of 8.2 Barrers and high H₂/CH₄ selectivity of 263 for H₂/CH₄ separation. For another example, a poly[2,2′-bis-(3,4-dicarboxyphenyl) hexafluoropropane dianhydride-3,3′-dihydroxy-4,4′-diamino-biphenyl] polyimide-toluene-2,4-diurethane (abbreviated as 6FDA-HAB-TDI-4-1, molar ratio of HAB/TDI=4:1) membrane has high He permeance of 36.7 Barrers and high He/CH₄ selectivity of 245 for He/CH₄ separation. The 6FDA-HAB-TDI-4-1 membrane also has high H₂ permeance of 27.2 Barrers and high H₂/CH₄ selectivity of 181 for H₂/CH₄ separation. The 6FDA-HAB-TDI-4-1 membrane also has CO₂ permeance of 4.84 Barrers and high CO₂/CH₄ selectivity of 34.6 for CO₂/CH₄ separation.

The invention provides a process for separating at least one gas from a mixture of gases using the high selectivity poly(imide-urethane) membrane described in the present invention, the process comprising: (a) providing a high selectivity poly(imide-urethane) membrane described in the present invention which is permeable to said at least one gas; (b) contacting the mixture on one side of the high selectivity poly(imide-urethane) membrane described in the present invention to cause said at least one gas to permeate the membrane; and (c) removing from the opposite side of the membrane a permeate gas composition comprising a portion of said at least one gas which permeated said membrane.

The high selectivity poly(imide-urethane) membrane described in the present invention is especially useful in the purification, separation or adsorption of a particular species in the liquid or gas phase. In addition to separation of pairs of gases, the high selectivity poly(imide-urethane) membrane described in the present invention may, for example, be used for the desalination of water by reverse osmosis or for the separation of proteins or other thermally unstable compounds, e.g. in the pharmaceutical and biotechnology industries. The high selectivity poly(imide-urethane) membrane described in the present invention may also be used in fermenters and bioreactors to transport gases into the reaction vessel and transfer cell culture medium out of the vessel. Additionally, the high selectivity poly(imide-urethane) membrane described in the present invention may be used for the removal of microorganisms from air or water streams, water purification, ethanol production in a continuous fermentation/membrane pervaporation system, and in detection or removal of trace compounds or metal salts in air or water streams.

The high selectivity poly(imide-urethane) membrane described in the present invention is especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of He, CO₂ or H₂S from natural gas, H₂ from N₂, CH₄, and Ar in ammonia purge gas streams, H₂ recovery in refineries, olefin/paraffin separations such as propylene/propane separation, xylene separations, iso/normal paraffin separations, liquid natural gas separations, C₂+ hydrocarbon recovery. Any given pair or group of gases that differ in molecular size, for example nitrogen and oxygen, carbon dioxide and methane, hydrogen and methane or carbon monoxide, helium and methane, can be separated using the high selectivity poly(imide-urethane) membrane described in the present invention. More than two gases can be removed from a third gas. For example, some of the gas components which can be selectively removed from a raw natural gas using the high selectivity poly(imide-urethane) membrane described herein include carbon dioxide, oxygen, nitrogen, water vapor, hydrogen sulfide, helium, and other trace gases. Some of the gas components that can be selectively retained include hydrocarbon gases. When permeable components are acid components selected from the group consisting of carbon dioxide, hydrogen sulfide, and mixtures thereof and are removed from a hydrocarbon mixture such as natural gas, one module, or at least two in parallel service, or a series of modules may be utilized to remove the acid components. For example, when one module is utilized, the pressure of the feed gas may vary from 275 kPa to about 2.6 MPa (25 to 4000 psi). The differential pressure across the membrane can be as low as about 70 kPa or as high as 14.5 MPa (about 10 psi or as high as about 2100 psi) depending on many factors such as the particular membrane used, the flow rate of the inlet stream and the availability of a compressor to compress the permeate stream if such compression is desired. Differential pressure greater than about 14.5 MPa (2100 psi) may rupture the membrane. A differential pressure of at least 0.7 MPa (100 psi) is preferred since lower differential pressures may require more modules, more time and compression of intermediate product streams. The operating temperature of the process may vary depending upon the temperature of the feed stream and upon ambient temperature conditions. Preferably, the effective operating temperature of the membranes of the present invention will range from about −50° to about 150° C. More preferably, the effective operating temperature of the high selectivity poly(imide-urethane) membrane of the present invention will range from about −20° to about 100° C., and most preferably, the effective operating temperature of the membranes of the present invention will range from about 25° to about 100° C.

The high selectivity poly(imide-urethane) membrane described in the present invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which the high selectivity poly(imide-urethane) membrane described in the present invention may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The high selectivity poly(imide-urethane) membrane described in the present invention may incorporate a species that adsorbs strongly to certain gases (e.g. cobalt porphyrins or phthalocyanines for O₂ or silver (I) for ethane) to facilitate their transport across the membrane.

The high selectivity poly(imide-urethane) membrane described in the present invention also has immediate application to concentrate olefin in a paraffin/olefin stream for olefin cracking application. For example, the high selectivity poly(imide-urethane) membrane described in the present invention can be used for propylene/propane separation to increase the concentration of the effluent in a catalytic dehydrogenation reaction for the production of propylene from propane and isobutylene from isobutane. Therefore, the number of stages of a propylene/propane splitter that is required to get polymer grade propylene can be reduced. Another application for the high selectivity poly(imide-urethane) membrane described in the present invention is for separating isoparaffin and normal paraffin in light paraffin isomerization and MaxEne™, a process for enhancing the concentration of normal paraffin (n-paraffin) in the naphtha cracker feedstock, which can be then converted to ethylene.

The high selectivity poly(imide-urethane) membrane described in the present invention can also be operated at high temperature to provide the sufficient dew point margin for natural gas upgrading (e.g, CO₂ removal from natural gas). The high selectivity poly(imide-urethane) membrane described in the present invention can be used in either a single stage membrane or as the first or/and second stage membrane in a two stage membrane system for natural gas upgrading.

The high selectivity poly(imide-urethane) membrane described in the present invention may also be used in the separation of liquid mixtures by pervaporation, such as in the removal of organic compounds (e. g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using the high selectivity poly(imide-urethane) membrane described in the present invention is the deep desulfurization of gasoline and diesel fuels by a pervaporation membrane process similar to the process described in U.S. Pat. No. 7,048,846, incorporated by reference herein in its entirety. The high selectivity poly(imide-urethane) membrane described in the present invention that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using the self-cross-linked aromatic polyimide polymer membrane described in the present invention include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of poly[2,2′-bis-(3,4-dicarboxyphenyl) hexafluoropropane dianhydride-3,3′-dihydroxy-4,4′-diamino-biphenyl-3,5-diaminobenzoic acid] polyimide-toluene-2,4-diurethane (Abbreviated as 6FDA-HAB-TDI-5-4) Membrane

6.78 g (15 mmol of hydroxyl groups) of poly[2,2′-bis-(3,4-dicarboxyphenyl) hexafluoropropane dianhydride-3,3′-dihydroxy-4,4′-diamino-biphenyl] polyimide (abbreviated as 6FDA-HAB, synthesized by polycondensation reaction of 2,2′-bis-(3,4-dicarboxyphenyl) hexafluoropropane dianhydride (6FDA) and 3,3′-dihydroxy-4,4′-diamino-biphenyl (HAB)) was dissolved in 38.4 g of anhydrous DMAc solvent. The mixture was stirred for 5 h at room temperature to completely dissolve 6FDA-HAB in DMAc. 1.05 g (6.0 mmol) of tolylene-2,4-diisocyanate (TDI, from Sigma-Aldrich) was added to the solution under stirring. The solution was mixed for 20 h at 60° C. to form a homogeneous solution. The solution was then cast onto the surface of a clean glass plate, and the solvent was evaporated at 60° C. for 12 h. The resulting membrane was detached from the glass plate and further dried at 200° C. for 48 h in vacuum to form poly[2,2′-bis-(3,4-dicarboxyphenyl) hexafluoropropane dianhydride-3,3′-dihydroxy-4,4′-diamino-biphenyl-3,5-diaminobenzoic acid] polyimide-toluene-2,4-diurethane (abbreviated as 6FDA-HAB-TDI-5-4) membrane.

### Example 2

### Preparation of poly[2,2′-bis-(3,4-dicarboxyphenyl) hexafluoropropane dianhydride-3,3′-dihydroxy-4,4′-diamino-biphenyl-3,5-diaminobenzoic acid] polyimide-toluene-2,4-diurethane (Abbreviated as 6FDA-HAB-TDI-4-1) Membrane

7.5 g (16 mmol of hydroxyl groups) of 6FDA-HAB polyimide was dissolved in 36.6 g of anhydrous DMAc solvent. The mixture was stirred for 5 h at room temperature to completely dissolve 6FDA-HAB in DMAc. 0.35 g (2.0 mmol) of tolylene-2,4-diisocyanate (TDI, from Sigma-Aldrich) was added to the solution under stirring. The solution was mixed for 20 h at 60° C. to form a homogeneous solution. The solution was then cast onto the surface of a clean glass plate, and the solvent was evaporated at 60° C. for 12 h. The resulting membrane was detached from the glass plate and further dried at 200° C. for 48 h in vacuum to form poly[2,2′-bis-(3,4-dicarboxyphenyl) hexafluoropropane dianhydride-3,3′-dihydroxy-4,4′-diamino-biphenyl-3,5-diaminobenzoic acid] polyimide-toluene-2,4-diurethane (abbreviated as 6FDA-HAB-TDI-4-1) membrane.

### Example 3

### Gas Separation Performance of 6FDA-HAB-TDI-5-4 and 6FDA-HAB-TDI-4-1 Membranes

The permeabilities of He, H₂, CO₂ and CH₄ (P_{He}, P_{H2}, P_{CO2}, and P_{CH4}, respectively) and ideal selectivities for He/CH₄ (α_{He/CH4}), H₂/CH₄ (α_{H2/CH4}), and CO₂/CH₄ (α_{CO2/CH4}) of the 6FDA-HAB-TDI-5-4 and 6FDA-HAB-TDI-4-1 membranes were measured by pure gas measurements at 50° C. under 690 kPa (100 psig) single gas pressure. The results are summarized in Tables 1-3. It can be seen from Table 1 that 6FDA-HAB-TDI-5-4 membrane has He permeance of 14.8 Barrers and high He/CH₄ selectivity of 651 for He/CH₄ separation. 6FDA-HAB-TDI-4-1 Membrane has high He permeance of 36.7 Barrers and high He/CH₄ selectivity of 245 for He/CH₄ separation. Tables 2 and 3 show that 6FDA-HAB-TDI-5-4 and 6FDA-HAB-TDI-4-1 membranes also have high selectivities for H₂/CH₄ and CO₂/CH₄ separations.

TABLE 1
Pure gas permeation results for 6FDA-HAB-TDI-5-4 and
6FDA-HAB-TDI-4-1 membranes for He/CH₄ separation*

| Membrane | P_{He} (Barrer) | α_{He/CH4} |
|---|---|---|
| 6FDA-HAB-TDI-5-4 | 14.8 | 651 |
| 6FDA-HAB-TDI-4-1 | 36.7 | 245 |

Tested at 50° C. and 690 kPa (100 psig); 1 Barrer=10⁻¹⁰ cm³(STP)·cm/cm²·sec·cmHg

TABLE 2
Pure gas permeation results for 6FDA-HAB-TDI-5-4 and
6FDA-HAB-TDI-4-1 membranes for H₂/CH₄ separation*

| Membrane | P_{H2} (Barrer) | α_{H2/CH4} |
|---|---|---|
| 6FDA-HAB-TDI-5-4 | 8.23 | 361 |
| 6FDA-HAB-TDI-4-1 | 27.2 | 181 |

Tested at 50° C. and 690 kPa (100 psig); 1 Barrer=10⁻¹⁰ cm³(STP)·cm/cm²·sec·cmHg

TABLE 3
Pure gas permeation results for 6FDA-HAB-TDI-5-4 and
6FDA-HAB-TDI-4-1 membranes for CO₂/CH₄ separation*

| Membrane | P_{CO2} (Barrer) | α_{CO2/CH4} |
|---|---|---|
| 6FDA-HAB-TDI-5-4 | 0.869 | 38.1 |
| 6FDA-HAB-TDI-4-1 | 4.84 | 34.6 |

Tested at 50° C. and 690 kPa (100 psig); 1 Barrer=10⁻¹⁰ cm³(STP)·cm/cm²·sec·cmHg

### Specific Embodiments

While the following is described in conjunction with specific embodiments, it will be understood that this description is intended to illustrate and not limit the scope of the preceding description and the appended claims.

A first embodiment of the invention is an apparatus comprising a high selectivity poly(imide-urethane) membrane described in the present invention comprises poly(imide-urethane) polymer with a plurality of repeating units of formula (I):

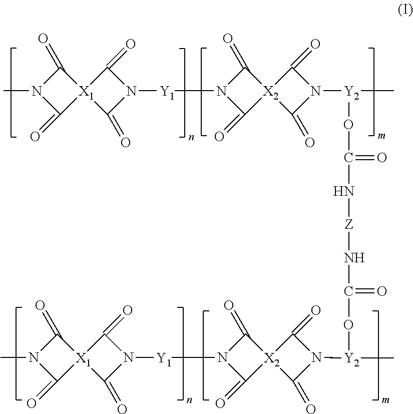

An embodiment of the invention is one, any or all of prior embodiments in this paragraph up through the first embodiment in this paragraph, wherein X₁ and X₂ are selected from the group consisting of:

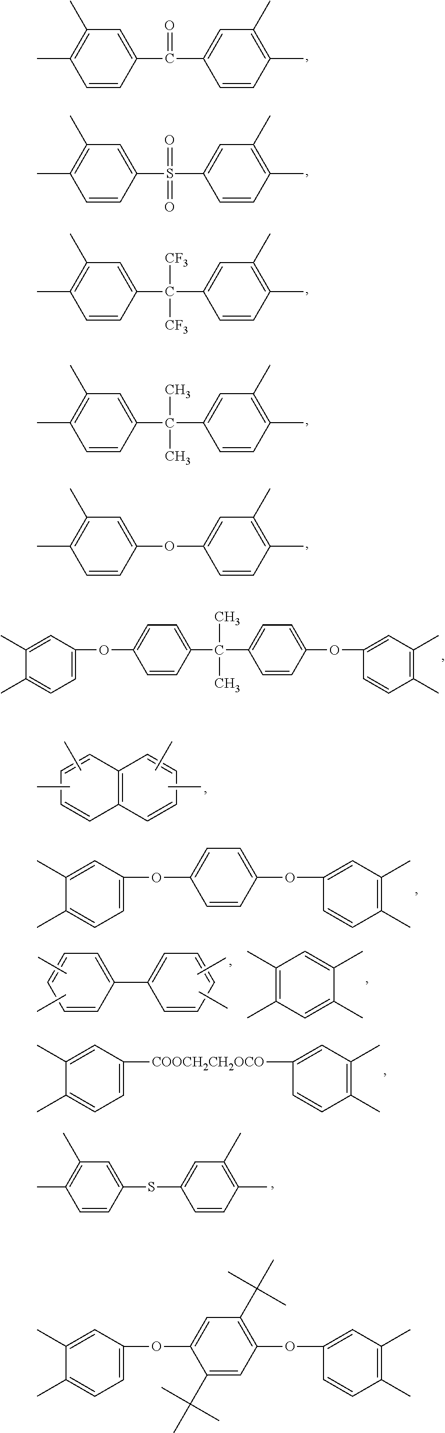

and mixtures thereof, respectively; X₁ and X₂ are the same or different from each other. An embodiment of the invention is one, any or all of prior embodiments in this paragraph up through the first embodiment in this paragraph, wherein Y₁ is selected from the group consisting of:

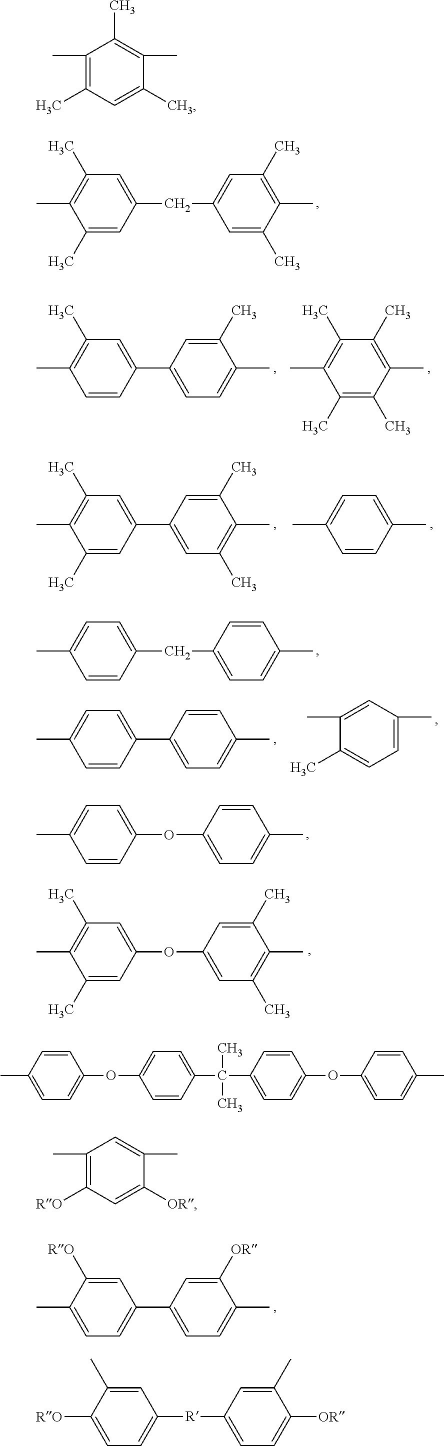

and mixtures thereof. An embodiment of the invention is one, any or all of prior embodiments in this paragraph up through the first embodiment in this paragraph, wherein —R′— is selected from the group consisting of:

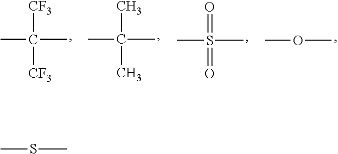

and mixtures thereof. An embodiment of the invention is one, any or all of prior embodiments in this paragraph up through the first embodiment in this paragraph, wherein —R″— is selected from the group consisting of —H, COCH₃, and mixtures thereof. An embodiment of the invention is one, any or all of prior embodiments in this paragraph up through the first embodiment in this paragraph, wherein Y₂—O— is selected from the group consisting of:

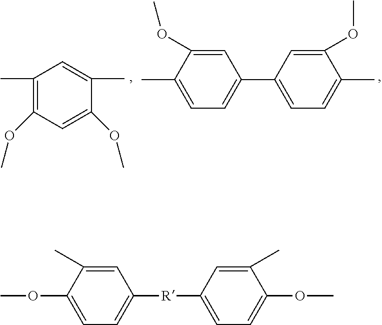

and mixtures thereof. An embodiment of the invention is one, any or all of prior embodiments in this paragraph up through the first embodiment in this paragraph, wherein —R′— is selected from the group consisting of:

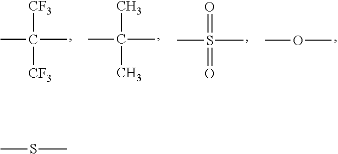

and mixtures thereof. An embodiment of the invention is one, any or all of prior embodiments in this paragraph up through the first embodiment in this paragraph, wherein —Z— is selected from the group consisting of:

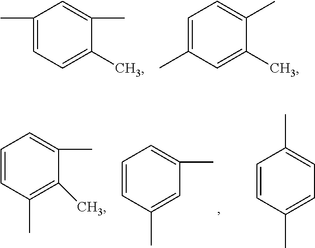

and mixtures thereof; n and m are independent integers from 2 to 500; the molar ratio of n/m is in a range of 120 to 201. An embodiment of the invention is one, any or all of prior embodiments in this paragraph up through the first embodiment in this paragraph, wherein the poly(imide-urethane) membrane comprises both imide segments and urethane segments that provide high selectivities for gas separations. An embodiment of the invention is one, any or all of prior embodiments in this paragraph up through the first embodiment in this paragraph, wherein the selective layer surface of the poly(imide-urethane) membrane is coated with a thin layer of high permeability material selected from the group consisting of a polysiloxane, a fluoro-polymer, a thermally curable silicone rubber, or a UV radiation curable epoxy silicone. An embodiment of the invention is one, any or all of prior embodiments in this paragraph up through the first embodiment in this paragraph, wherein the membrane is fabricated into any convenient geometry such as flat sheet (or spiral wound), tube, or hollow fiber.

A second embodiment of the invention is a process of making a high selectivity poly(imide-urethane) membrane, comprising preparing an organic solution consisting of certain mole ratio of an organo diisocyanate and a polyimide comprising hydroxyl functional groups that can react with the isocyanate groups; forming a poly(imide-urethane) pre-polymer solution by allowing the two chemicals to react for at least 4 hours at about 30° C. to about 150° C.; coating the poly(imide-urethane) pre-polymer solution on a porous polymeric membrane substrate or on a polymeric cloth substrate or on a clean glass plate; removing the organic solvents from the coating layer to form a membrane; and drying and curing the poly(imide-urethane) pre-polymer membrane to form poly(imide-urethane) polymer membrane. An embodiment of the invention is one, any or all of prior embodiments in this paragraph up through the second embodiment in this paragraph, wherein the organo diisocyanate is toluene-2,4-diisocyanate. An embodiment of the invention is one, any or all of prior embodiments in this paragraph up through the second embodiment in this paragraph, wherein the selective layer surface of the poly(imide-urethane) membrane is coated with a thin layer of high permeability material selected from the group consisting of a polysiloxane, a fluoro-polymer, a thermally curable silicone rubber, or a UV radiation curable epoxy silicone. An embodiment of the invention is one, any or all of prior embodiments in this paragraph up through the second embodiment in this paragraph, wherein the effective operating temperature of the membranes is in a range from about −50° to about 150° C., more preferably about −20° to about 100° C., and most preferably about 25° to about 100° C.

A third embodiment of the invention is a process of using a high selectivity poly(imide-urethane) membranes for separating at least one gas from a mixture of gases, the process comprising providing a high selectivity poly(imide-urethane) membrane which is permeable to the at least one gas; contacting the mixture on one side of the high selectivity poly(imide-urethane) membrane described in the present invention to cause the at least one gas to permeate the membrane; and removing from the opposite side of the membrane a permeate gas composition comprising a portion of the at least one gas which permeated the membrane. An embodiment of the invention is one, any or all of prior embodiments in this paragraph up through the third embodiment in this paragraph, wherein the membrane may be used for helium separation. An embodiment of the invention is one, any or all of prior embodiments in this paragraph up through the third embodiment in this paragraph, wherein the membrane is used for hydrogen separation. An embodiment of the invention is one, any or all of prior embodiments in this paragraph up through the third embodiment in this paragraph, wherein the membrane is used for liquid separations such as desalination. An embodiment of the invention is one, any or all of prior embodiments in this paragraph up through the third embodiment in this paragraph, wherein the membrane is used for liquid separations such as pervaporations.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A poly(imide-urethane) membrane comprising:
a high selectivity poly(imide-urethane) membrane described in the present invention comprises poly(imide-urethane) polymer with a plurality of repeating units of formula (I):

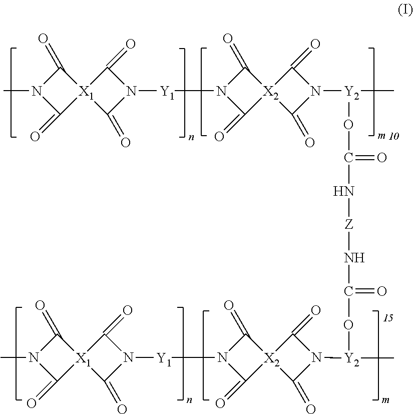

2. The membrane of claim 1, wherein X₁ and X₂ are selected from the group consisting of: 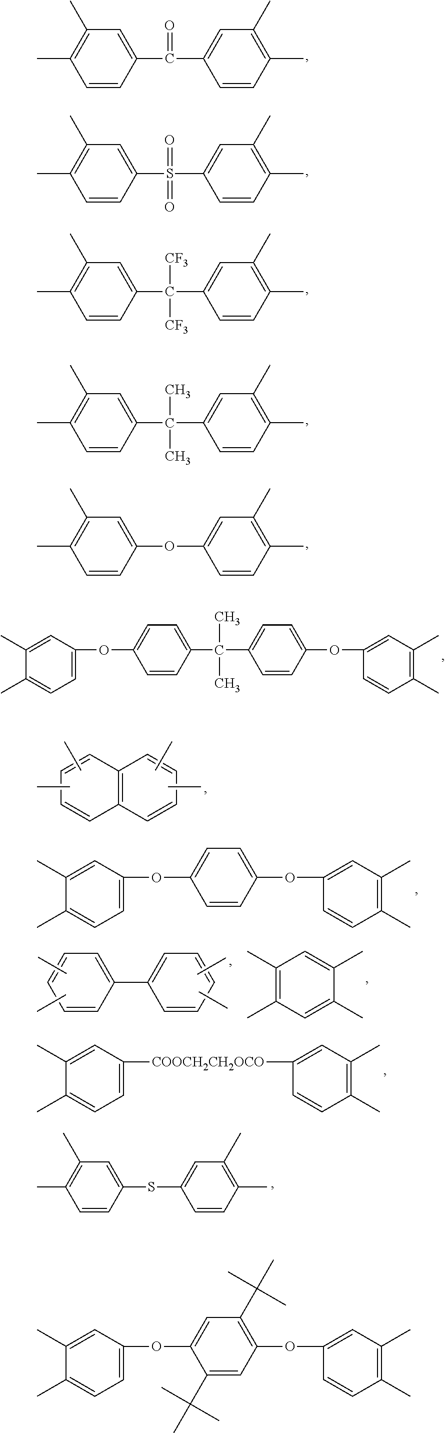
and mixtures thereof, respectively; X₁ and X₂ are the same or different from each other.

3. The membrane of claim 1, wherein Y₁ is selected from the group consisting of: 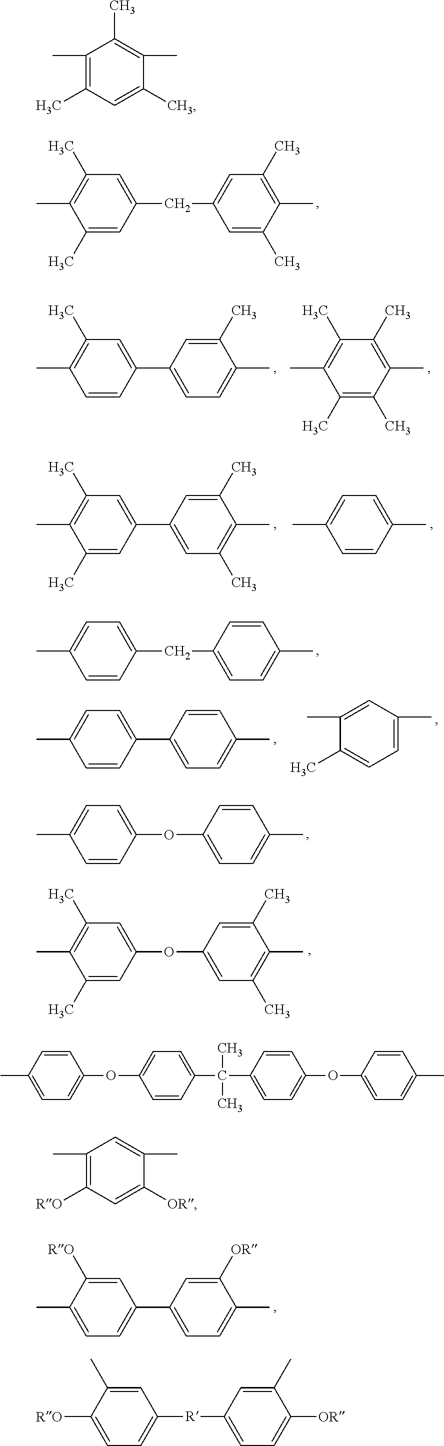
and mixtures thereof.

4. The membrane of claim 3, wherein —R′— is selected from the group consisting of: 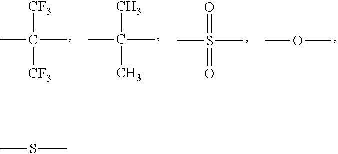
and mixtures thereof.

5. The membrane of claim 3, wherein —R″— is selected from the group consisting of —H, COCH₃, and mixtures thereof.

6. The membrane of claim 1, wherein Y₂—O— is selected from the group consisting of: 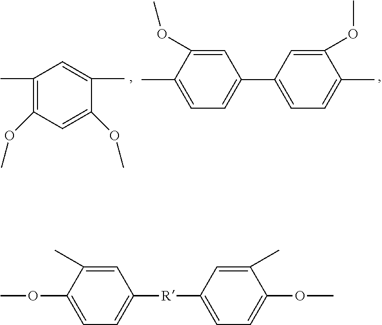
and mixtures thereof.

7. The membrane of claim 6, wherein —R′— is selected from the group consisting of: 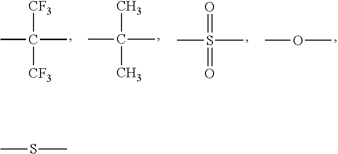
and mixtures thereof.

8. The membrane of claim 1, wherein —Z— is selected from the group consisting of: 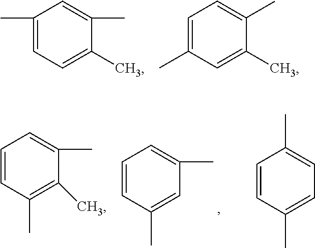
and mixtures thereof; n and m are independent integers from 2 to 500; the molar ratio of n/m is in a range of 1:20 to 20:1.

9. The membrane of claim 1, wherein the poly(imide-urethane) membrane comprises both imide segments and urethane segments that provide high selectivities for gas separations.

10. The membrane of claim 1, wherein the selective layer surface of the poly(imide-urethane) membrane is coated with a thin layer of high permeability material selected from the group consisting of a polysiloxane, a fluoro-polymer, a thermally curable silicone rubber, or a UV radiation curable epoxy silicone.

11. The membrane of claim 1, wherein the membrane is fabricated into any convenient geometry such as flat sheet (or spiral wound), tube, or hollow fiber.

12. A process of making a high selectivity poly(imide-urethane) membrane, comprising:
preparing an organic solution consisting of certain mole ratio of an organo diisocyanate and a polyimide comprising hydroxyl functional groups that can react with the isocyanate groups;
forming a poly(imide-urethane) pre-polymer solution by allowing the two chemicals to react for at least 4 hours at about 30° C. to about 150° C.;
coating the poly(imide-urethane) pre-polymer solution on a porous polymeric membrane substrate or on a polymeric cloth substrate or on a clean glass plate;
removing the organic solvents from the coating layer to form a membrane; and
drying and curing the poly(imide-urethane) pre-polymer membrane to form poly(imide-urethane) polymer membrane.

13. The process of claim 12, wherein the organo diisocyanate is toluene-2,4-diisocyanate.

14. The process of claim 12, wherein the selective layer surface of the poly(imide-urethane) membrane is coated with a thin layer of high permeability material selected from the group consisting of a polysiloxane, a fluoro-polymer, a thermally curable silicone rubber, or a UV radiation curable epoxy silicone.

15. The process of claim 12, wherein the effective operating temperature of the membranes is in a range from about −50° to about 150° C., more preferably about −20° to about 100° C., and most preferably about 25° to about 100° C.

16. A process of using a high selectivity poly(imide-urethane) membranes for separating at least one gas from a mixture of gases, the process comprising:
providing a high selectivity poly(imide-urethane) membrane which is permeable to said at least one gas;
contacting the mixture on one side of the high selectivity poly(imide-urethane) membrane described in the present invention to cause said at least one gas to permeate the membrane; and
removing from the opposite side of the membrane a permeate gas composition comprising a portion of said at least one gas which permeated said membrane.

17. The process of claim 16, wherein the membrane may be used for helium separation.

18. The process of claim 16, wherein the membrane is used for hydrogen separation.

19. The process of claim 16, wherein the membrane is used for liquid separations such as desalination.

20. The process of claim 16, wherein the membrane is used for liquid separations such as pervaporations.
